(19) United States
(12) Patent Application Publication
(10) Pub. No.: US 2022/0088893 A1
(43) Pub. Date: Mar. 24, 2022

(54) ROBOTIC TERMINAL EFFECTOR FOR AUTOMATIC PLACEMENT OF INSERTS IN A COMPOSITE PANEL OF THE SANDWHICH TYPE WITH A CELLULAR CORE

(71) Applicant: ECOLE SUPERIEURE DES TECHNOLOGIES INDUSTRIELLES AVANCEES, BIDART (FR)

(72) Inventors: Maylis UHART, HASPARREN (FR); Serge DURRIEU, MERIGNAC (FR); Vincent MAGIMEL-PELONNIER, BORDEAUX (FR); Francis SEDEILHAN, BAYONNE (FR)

(21) Appl. No.: 17/422,610

(22) PCT Filed: Jan. 14, 2020
(86) PCT No.: PCT/FR2020/050043

§ 371 Date: Sep. 20, 2021

(30) Foreign Application Priority Data
Jan. 15, 2019 (FR) 19 00372

(51) Int. Cl. B29C 70/84; B29C 70/68; B25J 15/06; B25J 13/08; B25J 9/16

(52) U.S. Cl. CPC B29C 70/84; B29C 70/681; B25J 9/1697; B25J 13/081; B25J 15/0616

(57) ABSTRACT

A robotic terminal effector for automatic placement of an insert in a cavity formed in a composite panel of the sandwich type with a cellular core. The insert including an upper flange having a resin inlet orifice and a resin outlet orifice. The effector being intended to be mounted on a carrier, and having a contact body with a contact surface. The contact surface having a means for injecting resin into an empty space delimited by the insert and the cavity when the insert is positioned in the cavity, and a means for grasping hold of the insert by suction. The resin-injection and grasping means being configured in such a way as to leave the contact surface free to be pressed firmly against an upper face of the composite panel so as to generate a continuous sealed region around the cavity while the insert is being placed in the cavity.

This application is a National Stage of International Application No. PCT/FR2020/050043, having an International Filing Date of 14 Jan. 2020, which designated the United States of America, and which International Application was published under PCT Article 21(2) as WO Publication No. 2020/148500 A1, which claims priority from and the benefit of French Patent Application No.19/00,372, filed on 15 Jan. 2019, the disclosures of which are incorporated herein by reference in their entireties.

### BACKGROUND

### 1. Field

The present disclosure relates to a robotic terminal effector for automatically installing inserts in a sandwich type panel made of composite material with a cellular core. The effector is intended to be mounted on the end of a robot arm. The present disclosure also relates to an assembly integrating the effector. The present disclosure also relates to a method for automatically installing an insert implementing this assembly.

### 2. Brief Description Of Related Developments

Sandwich type panels made of composite material with a cellular core generally comprise a central layer with a cellular structure with weak mechanical properties inserted between two panels that are much thinner than the central cellular layer, but which have excellent mechanical properties.

Throughout the remainder of the description, such a panel will be denoted using the term “sandwich panel” or “panel”.

Sandwich panels with a cellular core have very high stiffness properties, whilst advantageously having low density. They are currently used in the sector of naval, aeronautical, motor vehicle and railway construction for reinforcing mechanical structures subject to high constraints, whilst minimizing the problem of weight.

The sandwich panels are attached, for example, to a metal structure to reinforce said structure. The panels also can be integrated in complex assemblies for forming cabin structures.

In general, in order to form these structures, inserts are used that are introduced into a cavity produced in the sandwich panel. These inserts are added parts, which may or may not be metal, that form supports for accommodating an attachment system for transferring mechanical stresses.

A known conventional method for installing inserts comprises the following steps:
producing a cavity in a composite panel;
positioning an insert in the housing;
injecting a resin type substance into the space remaining between the insert and the cavity;
solidifying the substance in order to attach the insert in the housing.

Depending on the use of the structures, the inserts are distributed over the entire surface of the panel or over part of the surface of the panel. The number and the position of the inserts in the panel are predetermined.

Conventionally, the method described above is implemented manually and the production of such panels involves an excessively high cost and requires qualified operators. It is difficult to apply, for example, in the motor vehicle sector, in which motor vehicles are assembled at very high production rates or, for example, for satellite panels, for which the number of inserts is relatively high. Therefore, a major requirement exists for automating the installation of inserts.

Various methods that are already known involve partially automating the method for installing inserts described above or the set of steps.

In general, a device for automatically installing inserts in a known panel comprises a set of modules or effectors that can move vertically, independently of one another in a vertical direction and in a horizontal plane. Each of the modules is associated with tooling for completing one of the steps of the method for installing inserts.

A device is known, for example, from document WO 2014/060027 for automatically installing inserts in a composite panel comprising an automated effector intended to introduce the insert into a cavity provided in the composite panel and another automated effector comprising a resin injector intended to fill the empty space delimited by the insert and the wall of the cavity with resin.

The known solutions are not completely satisfactory. They are mainly adapted for installing inserts in a panel in series, which panel has a flat surface, but are difficult to apply in the event that the panel has complex geometry, and in particular when it has a certain curvature. Indeed, all these solutions propose using a pressing interface, which is a rigid part previously attached to the insert. This interface has a hard pressing surface, which does not take into account the curvature of the surface around the zone for installing the insert. Furthermore, it does not allow good adhesion and a seal to be guaranteed between the pressing surface and the upper face of the panel. Thus, the risks of the effector slipping on the panel are significant. Furthermore, these solutions must provide a module for recovering this interface once the insert is attached in the cavity of the panel, which increases the complexity of the method and the device and increases the bulk of the device.

In order to be able to automate all the steps of the method for installing an insert, the known solutions propose assigning a tooling function per module or effector. However, having to move the various effectors between each of the steps of the method makes the automation method more complex and requires precise control of the repositioning of the effector for each of the steps. In particular, after having positioned the insert in the cavity, the resin injector, which injector is in the form of a needle, needs to be properly positioned in the orifice for bonding the insert.

Furthermore, the known effectors are very bulky, which does not allow the effector to install inserts in certain zones of parts with a complex geometric structure, such as the parts intended for the cabin of an airplane.

The aim of the present disclosure is to overcome the disadvantages of the prior art.

### SUMMARY

A robotic terminal effector is proposed for automatically installing an insert in a cavity provided in a sandwich type panel made of composite material with a cellular core, said insert comprising an upper flange comprising a resin inlet orifice and a resin outlet orifice, said effector being intended to be mounted on a carrier, for example, a robot arm, and comprising:
a contact body having a contact surface;
the contact surface comprising:
a means for injecting resin into an empty space delimited by the insert and the cavity when the insert is positioned in the cavity; and
a means for grasping the insert by suction;

said resin injection and grasping means being configured in such a way as to leave the contact surface free to be pressed against an upper face of the composite panel by a set of pressing means, so as to generate a continuous sealed zone around the cavity while the insert is being installed in the cavity;
the injection means comprising a resin injection orifice formed in the contact surface and intended to be placed opposite the resin inlet orifice of the insert;
the means for grasping the insert comprising at least one suction orifice formed in the contact surface, said orifice being connected to a negative pressure circuit.

The contact body is made from a flexible material allowing the contact surface to conform to the curvature of the upper face of the composite panel when the contact surface is pressed against the panel by the pressing means. Thus, it is possible to automate the installation of the insert by an effector in a panel with a complex geometric surface, such as a curved surface, and not only in a panel having a flat surface.

Another advantage resulting from the use of the suction grasping means is to allow the effector to be able to grasp any type of insert.

The effector of the present disclosure thus allows several functions to be fulfilled with a single part, which is the contact body: grasping the insert and positioning it in the cavity, injecting the resin into the empty space delimited by the insert and the cavity when the insert is positioned in the cavity, which saves time and cost in the process for automating the installation of inserts in composite panels. Indeed, integrating the grasping means and the injection means directly into the same part of the effector, unlike the prior art, allows the means for injecting resin and the resin inlet orifice to be aligned when the insert is positioned in the cavity.

According to one technical feature of the present disclosure, the injection means comprises a resin injection orifice formed in the contact surface and intended to be placed opposite the resin inlet orifice of the insert.

According to another technical feature of the present disclosure, the means for grasping the insert comprises at least one suction orifice formed in the contact surface, said at least one orifice being connected to a negative pressure circuit.

According to one aspect of the present disclosure, the effector comprises an image sensor intended to be positioned opposite the resin outlet orifice of the insert via an opening formed in the contact surface.

According to one aspect of the present disclosure, the contact body is made of a sealing material.

Advantageously, the effector comprises a seal intended to be inserted between the contact surface and the zone around the cavity.

According to one aspect of the present disclosure, the effector comprises a contact detection sensor configured to detect the contact between the contact surface and the upper face of the panel in the vicinity of the cavity and to generate a control signal when the contact surface is in abutment against the upper face of the panel.

According to one aspect of the present disclosure, the effector comprises a tube extending between the resin injection orifice and a resin dispensing device.

Advantageously, the contact body and the tube form a single part.

According to one aspect of the present disclosure, the pressing means comprises a vacuum pad forming an end designed to come into abutment against the face of the panel, a connection end fitting and a hollow cylindrical body, said hollow cylindrical body comprising a downstream end connected to the connection end fitting and an upstream end connected to a negative pressure circuit.

Advantageously, the hollow cylindrical body is provided with a helical spring.

According to another aspect of the present disclosure, the effector comprises an attachment surface intended to be attached to a free end of the carrier, the contact body being a part detachably attached relative to the attachment surface by a sealed coupling means.

According to another aspect of the present disclosure, the sealed coupling means comprises a projecting element produced on a rear surface of the contact body or on a front surface of the attachment surface, which element is respectively housed in a housing produced on a front surface of the attachment interface or on a rear surface of the contact body.

According to another aspect, equipment is proposed for automatically installing inserts in a cavity provided in a panel comprising:
a robot arm comprising a free end;
an effector as defined above being attached to the free end of the robot arm by means of an attachment surface;
the robot arm comprising a frame, in which a resin dispensing device, a negative pressure device and a set of negative pressure circuits are housed.

According to another aspect, a method is proposed for automatically installing inserts in a cavity provided in a panel, implemented by the equipment defined above, comprising the following steps:
providing a panel comprising at least one cavity;
moving the effector, using the robot arm, in front of the cavity in accordance with the theoretical position of the cavity;
checking the alignment between the theoretical position of the cavity and the actual position of the cavity using the image sensor of the effector and determining the new coordinates of the actual position of the cavity;
moving the effector in front of the insert and positioning, using the image sensor, the effector in front of an insert in such a way that the image sensor is opposite the resin outlet orifice of the insert and the resin injection orifice of the effector is opposite the resin inlet orifice of the insert;
grasping the insert by suction by pressing a surface of the insert against the contact surface of the effector;
moving the effector provided with the insert in front of the cavity and positioning the insert in the cavity until the contact surface comes into contact with the upper face of the panel;
suction pressing, using the pressing means, the contact surface of the effector against the upper face of the panel in order to keep the panel in position when the resin is injected into the empty space of the cavity;
injecting the resin into the empty space delimited by the insert and the cavity through the resin injection orifice of the effector and the resin inlet orifice of the insert;
the image sensor detecting the end of the injection of resin when excess resin exits via the resin outlet orifice of the insert.

### BREIF DESCRIPTION OF THE DRAWINGS

Further features, details and advantages of the present disclosure will become apparent from reading the following detailed description and from analyzing the accompanying drawings, in which:

FIG. 1A is a schematic section view of an effector for installing an insert according to the present disclosure when grasping an insert by suction;

FIG. 1B is a section view of an insert positioned in the cavity;

FIG. 2 s a schematic section view of the effector of FIG. 1A with the insert positioned in the cavity;

FIG. 3A shows an enlarged exploded perspective view of the effector of FIG. 1A;

FIG. 3B shows another enlarged exploded perspective view of the effector of FIG. 1A;

FIG. 4 is an exploded view of the contact surface of the effector of FIG. 1A;

FIG. 5 is an exploded view of a variant of the contact surface of the effector of the present disclosure;

FIG. 6 shows a perspective view of an aspect of an assembly comprising the robot arm and the effector mounted at a free end of the robot arm;

FIG. 7 shows a partial profile section view of the robot arm of FIG. 6 with its free end equipped with an effector according to the present disclosure comprising a contact surface of FIG. 5;

FIG. 8 shows a flowchart of a method for automatically installing an insert in a cavity of a panel implemented by the assembly of FIG. 6.

### DETAILED DESCRIPTION

The drawings and the following description mainly contain elements of a certain nature. They therefore will not only be able to be used to better understand the present disclosure, but also to contribute to its definition, if applicable.

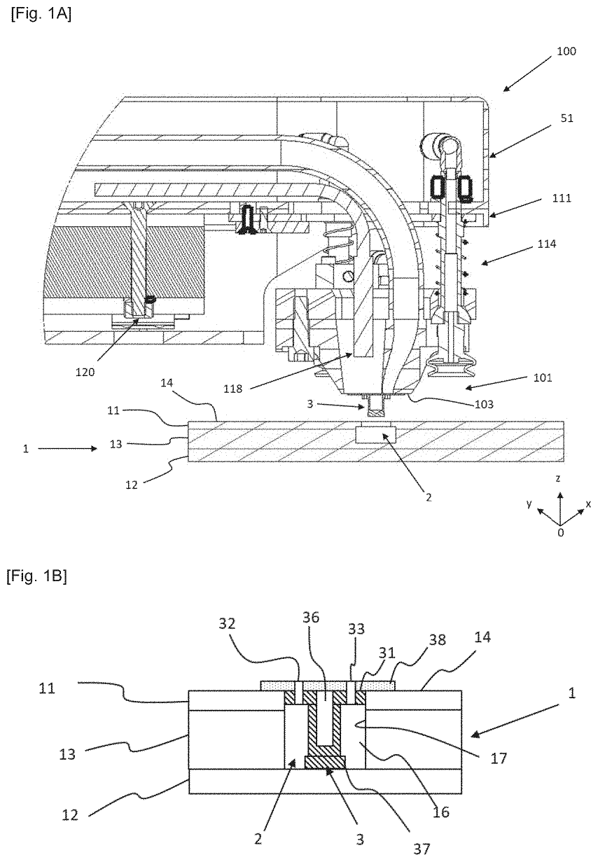

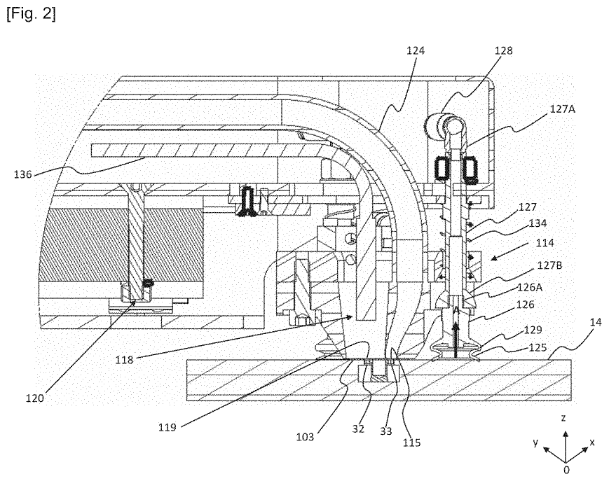

For the sake of clarity, the same numerical reference is used for FIGS. 1 to 7 to denote the same element of the effector according to the present disclosure.

The effector according to the present disclosure is described with reference to FIGS. 1, 2, 3, 4 and 5.

FIG. 1A schematically and partially shows a section view of an effector 100 according to one aspect of the present disclosure in a position for installing an insert 3 in a cavity 2 produced in a sandwich structure panel 1.

The sandwich panel 1 generally comprises an upper layer 11, a lower layer 12 and a central layer 13 with a cellular structure inserted between the two layers. The set of layers forms a stack. Each of the layers locally extends in a horizontal plane (XY).

The panel is generally held in position by an attachment device, not shown in FIG. 1A.

The cavity 2 is previously produced in the panel to accommodate the insert. As illustrated in FIG. 1B, the insert 3 comprises a hole 36 intended to accommodate an attachment means, an upper flange 31 and a lower flange 37. In general, and depending on the use of the sandwich panel, the panel can comprise a plurality of cavities distributed over the panel. The upper flange 31 comprises a first orifice and a second orifice, which are arranged diametrically opposed while respectively forming an inlet orifice 33 and an outlet orifice 32 for the resin. The insert comprises a pad 38 disposed on the upper flange 31. It allows the upper flange 31 to remain flush with the upper face 14 of the panel when the insert is positioned in the cavity and protects the hole 36 from the resin. This pad is subsequently removed in order to introduce the attachment means into the cavity. When the insert is positioned in the cavity, the insert 3 and the internal wall of the hole 17 delimit an empty space 16 for receiving the resin that is injected via the orifice 33. The resin allows the insert to be secured in the cavity once the resin has solidified.

Throughout the remainder of the description, the “direction of introduction of the insert” refers to a direction OZ perpendicular to the plane (XY), i.e. a direction normal to the surface of the panel.

For the sake of greater clarity hereafter, the terms “upper”, “lower”, “front”, “rear”, “upstream” and “downstream” are to be understood with reference to the arrangement of the effector in relation to the panel. Thus, the upper flange 31 is the flange of the insert 3 closest to the effector 100 and the lower flange 37 is the flange of the insert 3 furthest away from the effector. Similarly, a rear face of an element of the effector is the face furthest away from the panel and the front face of an element of the effector is the face closest to the panel. An upstream end of an element of the effector is the end furthest away from the panel and the downstream end of an element of the effector is the end closest to the panel.

The effector 100 of the present disclosure allows several functions to be fulfilled, namely grasping the insert from a store (not shown in the figures), introducing the insert into the cavity and injecting resin into the empty space of the cavity.

The effector 100 comprises a contact body 101 having a contact surface 103 intended to come into abutment against the upper face 14 of the panel and the pad 38 of the insert. The contact body 101 is in the form of a truncated cone, one of the bases of which forms the contact surface. FIG. 2 shows the contact body 101 of the effector in a position whereby one of the bases is in abutment against the upper face 14 of the panel, with the insert positioned in the cavity. The diameter of the contact surface formed by the base is greater than the diameter of the cavity on the surface of the panel, in such a way that the contact surface 103 forms a pressing surface against the upper face 14 of the panel around the cavity.

According to one variant, the contact body can be in the form of a truncated half-sphere, one of the bases of which forms the contact surface. Of course, the present disclosure is not limited to these two shapes only. The shape of the contact body is adapted as a function of any specific shape of the surface of the panel against which the contact body comes into abutment. This surface can be concave, for example.

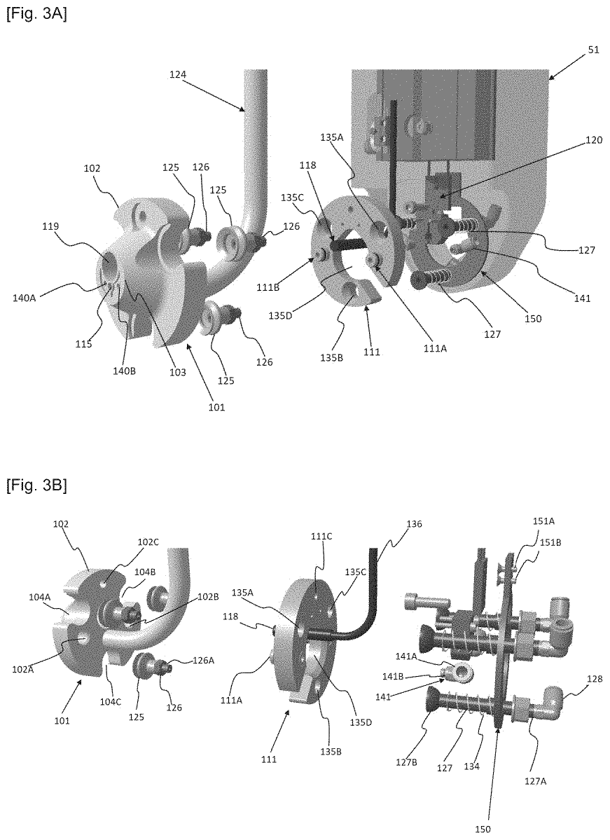

The contact surface 103 comprises one or more suction orifices each connected to a negative pressure circuit or to a common negative pressure circuit. Preferably, the contact surface 103 comprises a plurality of orifices substantially arranged at the center of the contact surface. By way of an example, the effector illustrated in FIGS. 3A, 4 and 5 comprises two suction orifices 140A, 140B. Each suction orifice is connected to the negative pressure circuit by means of a sealed connection end fitting 141 having a downstream end 141 B connected to the suction orifice 140A, 140B and an upstream end 141A connected to the negative pressure circuit. The assembly comprising the suction orifices, the sealed connection end fittings and the negative pressure circuit form the means for grasping the effector.

When the contact surface 103 is in contact with the pad 38 of the insert, a conventional negative pressure device, not shown in the figures, is activated to generate a negative pressure in the circuit connected to the suction orifices 140A, 140B in contact with the surface of the pad 38. The vacuum that is thus created presses the insert 3 against the contact surface 103 of the effector by suction. The insert is thus held in position against the contact surface of the effector and is ready to move from the zone for storing inserts toward the panel. Preferably, the insert is held against the contact surface by suction when the insert is introduced into the cavity and when resin is injected into the cavity.

The contact surface 103 further comprises a resin injection orifice 115 and an opening 119. When the contact surface is positioned in relation to the insert during the phase of grasping the insert by the effector, the resin injection orifice 115 is opposite the resin inlet orifice 33 of the insert 3 and an image sensor 118 is opposite the resin outlet orifice 32 of the insert 3 via the opening 119. The positioning of the effector in relation to the insert is completed using the image sensor 118. Thus, by virtue of the dual function integrated in the contact body, namely grasping the insert by suction and injecting resin, the effector can grasp the insert, whilst aligning the resin inlet orifice of the insert with the resin injection orifice of the contact body.

The injection orifice 115 is connected to a resin dispensing device by means of a tube 124, which extends between the injection orifice 115 and the end of the dispensing device. As shown in FIGS. 2, 3A and 3B, the contact body 101 is a solid body and the tube 124 comprises a portion directly formed in the contact body and a portion that extends outside the contact body 101 in order to connect to the end of the resin dispensing device. According to one aspect, the portion of the tube outside the contact body and the contact body are formed by a single part obtained by molding or by 3D printing. By way of a variant, the contact body 101 and the portion of the tube 124 outside the contact body can be formed by two separate parts. The assembly comprising the injection orifice and the tube form the resin injection means of the effector.

The effector 100 comprises a contact detection sensor 120 arranged in the effector in order to be positioned opposite the contact surface 103 of the effector and of the upper face of the panel 14 around the cavity 2. The contact detection sensor generates a control signal when the contact surface of the effector comes into contact with the upper face of the panel. This control signal is transmitted, for example, to a control unit of the robot arm to stop the vertical movement of the contact surface.

The effector comprises an image sensor 118 positioned opposite the resin outlet orifice 32 of the insert when said insert is held in contact against the contact surface via an opening 119 formed in the contact surface. The opening 119 extends from the contact surface of the contact body up to the rear surface of the contact body. When the insert 3 is positioned in the cavity 2, the resin is injected into the empty space 16 delimited by the insert 3 and the inner wall of the cavity 17. When the empty space is filled, any excess resin exits via the resin outlet orifice 32 of the insert. The image sensor 118 positioned opposite the outlet orifice 32 allows the presence of excess resin at the resin outlet orifice 32 of the insert to be detected and generates a control signal transmitted to a control unit of the resin dispensing device to interrupt the injection. More specifically, the control unit deactivates the resin dispensing device. The presence of the resin can be detected by the camera, for example, by a change of color or by a detection of movement.

As shown in FIGS. 1A and 2, the means for injecting resin and the means for grasping the insert of the present disclosure are configured in order to leave the contact surface 103 completely free in order to be able to be pressed against the upper face 14 of the panel and the pad 38 of the insert by pressing means 114, in order to generate a continuous sealed zone around the cavity. The contact body is made from a flexible material, which allows the contact surface to conform to the curvature of the upper face of the panel when pressing the contact surface against the panel. Preferably, the contact body is made from a material that also provides the seal. More specifically, during the grasping phase, when the insert 3 is held against the contact surface 103, the sealed zone is the contact zone between the suction orifices 140A, 140B and the pad 38 of the insert. During the phase of injecting resin into the empty space of the cavity, the contact zone between the resin injection orifice 115 and the resin outlet orifice 33 of the insert is also sealed in order to prevent resin leakage when resin is injected.

In order to guarantee the formation of this sealed zone, the contact body is made from a sealing material, such as silicon or any other type of material with flexibility. It can be polyurethane, for example. According to a particularly advantageous aspect, the contact body is a single part produced by 3D printing.

According to a variant as shown in FIG. 5, the effector comprises a seal 117 made from a sealing material that is attached by gluing, for example, to the contact surface 103 of the contact body. The seal is arranged on the contact surface in such a way that, when grasping the insert and injecting resin into the empty space of the cavity, it is inserted between the contact surface 103 and the pad 38 of the insert, as well as a zone of the upper face 14 of the panel around the cavity. Openings 117A, 1178, 117C and 117D are formed in the seal 117 and are respectively arranged opposite suction orifices 140A, 1408, the resin injection orifice 115 and the opening 119 for the camera.

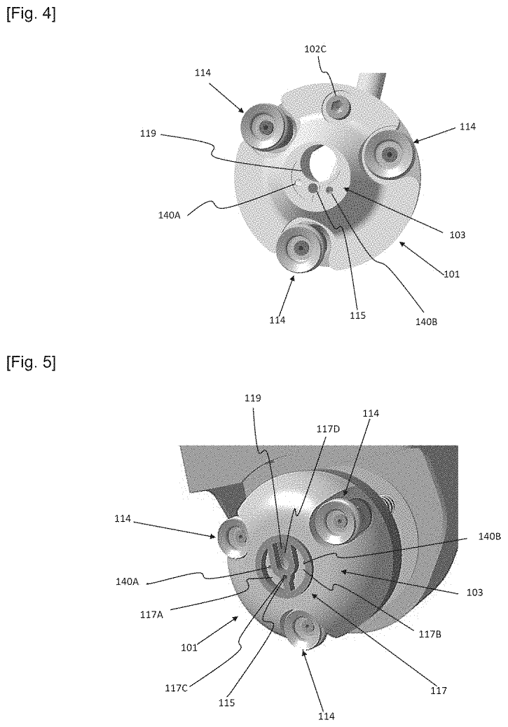

Preferably, and with reference to FIGS. 4 and 5, the effector comprises three pressing means 114 arranged around the zone of the cavity when the contact surface is pressed against the upper face of the panel. As shown in FIG. 2, each pressing means 114 comprises a suction pad 125, a connection end fitting 126 and a hollow cylindrical body 127. The suction pad 125 comprises a downstream end forming a pressing surface for coming into abutment on an upper face 14 of the panel and an upstream end connected to the connection end fitting. The connection end fitting 126 leads into, at the upstream end 126A thereof, the downstream end 127B of the hollow cylindrical body 127. The upstream end 127A of the hollow cylindrical body is connected to a negative pressure circuit by means of a sealed connection end fitting 128. For impact-free contact with the upper face 14 of the panel, and in order to properly conform to the shape of the panel, the suction pad 125 comprises a boot 129 connecting the downstream end of the suction pad to the connection end fitting 126.

Preferably, the connection end fitting 126 and the hollow cylindrical body 127 are made from a sealing material. In general, a conventional device comprising a set of clamps and seals allows the seal to be provided at the connection between the connection end fitting 126 and the cylindrical body 127. Similarly, a conventional device allows the seal to be provided for the connection between the upstream end 127A of the cylindrical body and the negative pressure circuit.

When the contact detection sensor 120 detects that the contact surface 103 is in contact with the upper face 14 of the panel, the sensor generates a signal that is transmitted to a negative pressure device in order to generate the negative pressure in the dedicated circuit and in the pressing means 114. This then results in a suction effect, shown by an arrow A in FIG. 2. The pressing means 114 and the panel 1 are then securely held by suction. During the phase of injecting resin into the empty space 16 of the insert, by virtue of the presence of the pressing means, the effector is thus locked in position in relation to the panel. This avoids any risk of the effector slipping in relation to the panel during the resin injection phase. When the end of the resin injection phase is detected by the camera 118, the negative pressure is interrupted, and the pressing means are no longer in abutment against the upper face of the panel.

Advantageously, each hollow cylindrical body 127 is provided with a helical spring 134 in such a way that the contact of the contact surface against the upper face of the panel is also dampened by the compression of the spring.

Moreover, the detection sensor 120 is adapted to check whether the grasping means are properly in abutment against the upper face 14 of the panel with the three suction pads 125 by measuring the compression of the springs 134 of the grasping means 114.

According to another advantage, by virtue of the presence of the springs 134, the pressing means 114 and the contact surface 103 of the effector engage together in such a way that the contact surface can conform to the shape of the panel around the cavity during pressing, whilst keeping the position of the effector fixed in relation to the panel during the resin injection phase. The helical spring allows the effector to adapt to a curved surface of the panel by virtue of the angular and linear compliance, in particular by virtue of the fact that the pressing means are independent of each other, thus allowing pressing against curved surfaces.

As shown by the exploded perspective views of FIGS. 3A and 3B, according to one aspect, the contact body 101 comprises a base 102 that is coupled with an attachment surface 111 intended to be attached to a free end 51 of a carrier, for example, a robot arm, using conventional attachment means, such as screws. Three notches 104A, 104B, 104C are provided in the base to allow through each pressing means 114.

Preferably, the contact body 101 is detachably attached to a front face of the attachment surface 111 by sealed coupling means. Thus, the contact body can be a single-use part and does not require washing between two insert installation cycles, for example, or when the reference resin used for bonding the insert in the cavity is changed. To this end, the coupling means can include a projecting element or a tenon produced, for example, on the rear face of the contact body 101 and a housing produced on the front face of the attachment surface 111, with the tenon and the housing engaging together to detachably attach the contact body to the attachment surface, and therefore to the free end of the robot arm.

According to one aspect, the base 102 can comprise two housings 102A, 102B not leading into the front face of the base, disposed on either side of the contact surface in which two tenons 111A, 111B are housed that are formed on the attachment surface 111. The tenons 111A and 111B allow the base to be positioned and oriented in relation to the attachment surface. The base and the attachment surface can be fixed together using an attachment means respectively received in the attachment holes 102C and 111C of the base of the attachment surface.

The contact body is a part preferably produced from a material, for example, polyethylene, limiting the adhesion of the resin on the internal wall of the contact body and of the injection tube.

As shown in FIGS. 3A and 3B, the attachment surface 111 is attached to a free end 51 of a carrier, for example, a robot arm, by means of a rigid attachment part 150. The attachment surface 111 comprises three peripheral openings 135A, 135B, 135C for allowing through the three hollow cylindrical bodies 127 of the pressing means 114 and a central opening 135D for the resin injection tube 124, the cable 136 of the camera 118, as well as the end fittings 141 connecting the negative pressure circuits to the suction orifices 140A, 140B. The rigid part 150 is attached to the free end of the robot arm using conventional attachment means, such as screws 151A, 151B.

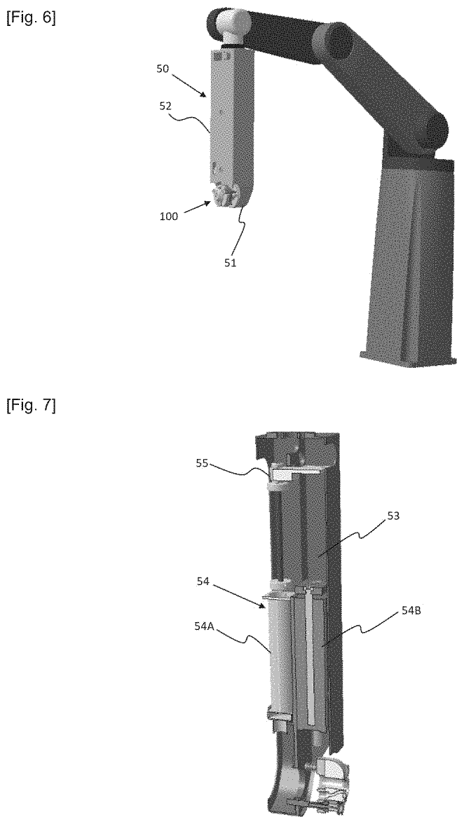

FIG. 6 shows an example of the integration of an effector 100 according to the present disclosure on the free end 51 of a robot arm 50 with several degrees of freedom. According to a particularly advantageous aspect, the robot arm comprises a frame 52 produced, for example, from polylactic acid (PLA). The length of the arm is selected as a function of the requirement of the application.

With more specific reference to FIG. 7, the arm 50 comprises a housing 53, in which a resin dispenser 54 and the negative pressure devices (not shown) are arranged. In the example shown in FIG. 7, the dispensing device 54 comprises two cartridges 54A, 54B with different resin in order to deliver a bi-component resin for bonding the insert in the cavity of the panel. The cartridges have a common end connected to a dispensing unit for injecting resin and another common end connected to the end of the resin injection tube.

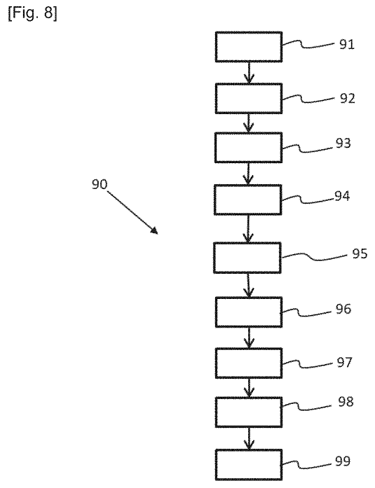

With reference to FIG. 8, a method for automatically installing inserts 90 in a cavity of a panel implementing the assembly integrating the effector of the present disclosure will now be described.

In a first step 91, the panel is previously installed and held in position on a work table. Cavities are produced using a suitable tool.

The inserts with different references are stored and available in an insert store provided in the vicinity of the work zone. Moreover, the inserts are present in a position and an orientation that facilitates the grasping step, thus allowing cycle time to be saved and facilitating the programming of the robot with a predefined orientation of the insert, for example, with the pad facing upward.

In a second step 92, the robot arm 50 moves the effector 100 in front of a cavity 2 previously produced in the panel in accordance with its theoretical position.

In a third step 93, a camera 118 mounted on the effector checks the alignment between the produced cavity and its theoretical position, in order to correct the position of the effector if necessary. During this checking step, the diameter and the quality of the perforation are also checked. If the perforation is not correct, a signal is transmitted to the operator. The operator must decide whether or not to continue with the insert installation procedure.

In a fourth step 94, the robot arm subsequently moves the effector 100 and positions it in front of the insert 3. More specifically, the contact surface 103 of the effector 100 is oriented toward the pad 38 of the insert 3, in such a way that the resin injection orifice 115 of the effector is positioned opposite the resin inlet orifice 33 of the insert 3 and that the image sensor 118 is opposite the resin outlet orifice 32 of the insert 3 via the opening 119. This positioning is implemented by virtue of the camera 118. The suction orifices 140A, 1408 of the contact surface 103 are brought together and brought into contact with the pad 38 of the insert.

In a fifth step 95, the negative pressure device is activated in order to generate a negative pressure in the circuit connected to the suction orifices. The pad 38 of the insert is securely held against the contact surface 103 by suction. In order to guarantee the suction grasping, the contact surface is produced from a sealing material, for example, from silicon, in order to obtain a sealed zone. The suction grasping means allow the inserts to be grasped irrespective of their reference.

In a sixth step 96, the robot moves the effector 100 with the insert in front of the cavity with the corrected position. The contact surface 103 of the effector is oriented toward the upper face 14 of the panel and is arranged in such a way that the axis of introduction of the insert and the axis of the cavity are aligned. The effector is moved along the normal to the surface, in the introduction direction OZ, toward the cavity until a contact detection sensor 120 detects that the contact surface 103 is in contact with the upper face 14 of the panel. More specifically, the contact detection sensor generates a control signal transmitted to the control unit of the robot arm to stop the vertical progression of the effector. The insert 3, which is held by the contact surface, is then positioned in the cavity with its upper flange 31 flush with the upper face of the panel as a result of the contact surface that could come into abutment directly on the upper face of the panel around the cavity, whilst holding the insert by means of the pad 38.

In a seventh step 97, when the contact detection sensor 120 detects that the insert 3 is correctly positioned in the cavity 2, it generates a control signal transmitted to the negative pressure device to generate a negative pressure in the circuits connected to the pressing means 114, which then suction presses the contact surface 103 against the upper face 14 of the panel, in order to hold it in position for injecting resin into the empty space of the cavity. Unlike the known insert installation system, in which a resin injection module needs to be moved, the injection orifice provided directly in the contact surface of the effector was already placed opposite the resin inlet orifice while the insert was grasped and is ready for injecting the resin. Furthermore, when the insert is grasped, the image sensor 118 is also positioned directly opposite the resin outlet orifice.

Advantageously, the contact surface is made of a sealing material. For this reason, by virtue of the suction pressing using pressing means 114, a continuous sealed zone is generated around the cavity, between the contact surface 103 with the pad 38 of the insert and the upper face 14 of the panel. The connection between the resin injection orifice 115 and the resin inlet orifice 33 is sealed for the resin injection phase. This avoids the risks of resin leaks at the interface between the contact surface and the upper flange of the insert and the panel. Advantageously, with the insert still being held by suction against the contact surface 103 of the effector during the resin injection phase, this helps to enhance the pressing of the contact surface against the upper face of the panel, and for this reason allows any risk of resin leakage at the injection orifice to be removed. Thus, during the entire resin injection phase, holding the insert against the contact surface of the effector, combined with pressing the contact surface against the upper face of the panel, avoids the risk of the effector slipping in relation to the panel and the risk of resin leakage.

In an eighth step 98, the resin dispensing device is then activated for injecting resin into the empty space of the cavity. When the empty space of the cavity is filled, excess resin exits via the outlet orifice 32 of the insert.

In a ninth step 99, the image sensor 118, for example, a camera, detects the presence of excess resin and transmits a control signal to the resin injection unit to stop the injection. The circuits connected to the pressing means and to the suction orifices are no longer under negative pressure. The contact surface 103 is no longer in abutment against the upper face 14 of the panel and the pad 38 of the insert. The effector is then free to be moved by the robot arm for a new insert installation cycle, for example.

If necessary, between two insert installation cycles, the robot positions the effector on a docking and cleaning station. Advantageously, it is also possible to change only the detachable part of the effector, namely the contact body 101, if necessary.

The present disclosure can be applied to any field where inserts or attachment means must be integrated in sandwich type panels made of composite material with a cellular core. The present disclosure particularly can be applied to the aeronautical, space, motor vehicle or railway fields.

The present disclosure is not limited to the examples described above; in particular, features of the illustrated examples can be combined together in variants that are not illustrated.

What is claimed is:

1. A robotic terminal effector for automatically installing an insert in a cavity provided in a sandwich type panel made of composite material with a cellular core, said insert comprising an upper flange comprising a resin inlet orifice and a resin outlet orifice, said effector being intended to be mounted on a carrier, for example, a robot arm, and comprising:
a contact body having a contact surface;
the contact surface comprising:
a means for injecting resin into an empty space delimited by the insert and the cavity when the insert is positioned in the cavity; and
a means for grasping the insert by suction;
said resin injection and grasping means being configured in such a way as to leave the contact surface free to be pressed against an upper face of the composite panel by a set of pressing means, so as to generate a continuous sealed zone around the cavity while the insert is being installed in the cavity.

2. The effector as claimed in claim 1, wherein the injection means comprises a resin injection orifice formed in the contact surface and intended to be placed opposite the resin inlet orifice of the insert.

3. The effector as claimed in claim 1, wherein the means for grasping the insert comprises at least one suction orifice formed in the contact surface, said at least one orifice being connected to a negative pressure circuit.

4. The effector as claimed in claim 1, wherein it comprises an image sensor intended to be positioned opposite the resin outlet orifice of the insert via an opening formed in the contact surface.

5. The effector as claimed in claim 1, wherein the contact body is made of a sealing material.

6. The effector as claimed in claim 1, wherein it comprises a seal intended to be inserted between the contact surface and the zone around the cavity.

7. The effector as claimed in claim 1, wherein it comprises a contact detection sensor configured to detect the contact between the contact surface and the upper face of the panel in the vicinity of the cavity and to generate a control signal when the contact surface is in abutment against the upper face of the panel.

8. The effector as claimed in claim 1, wherein it comprises a tube extending between the resin injection orifice and a resin dispensing device.

9. The effector as claimed in claim 8, wherein the contact body and the tube form a single part.

10. The effector as claimed in claim 1, wherein the pressing means comprises a suction pad forming an end designed to come into abutment against the upper face of the panel, a connection end fitting and a hollow cylindrical body, said hollow cylindrical body comprising a downstream end connected to the connection end fitting and an upstream end connected to a negative pressure circuit.

11. The effector as claimed in claim 10, wherein said hollow cylindrical body is provided with a helical spring.

12. The effector as claimed in claim 1, wherein it comprises an attachment surface intended to be attached to a free end of the carrier, the contact body being a part detachably attached relative to the attachment surface by a sealed coupling means.

13. The effector as claimed in claim 12, wherein the sealed coupling means comprises a projecting element produced on a rear surface of the contact body or on a front surface of the attachment surface, which element is respectively housed in a housing produced on a front surface of the attachment interface or on a rear surface of the contact body.

14. Equipment for automatically installing inserts in a cavity provided in a panel comprising:
a robot arm comprising a free end;
an effector comprising:
a means for injecting resin into an empty space delimited by the insert and the cavity when the insert is positioned in the cavity, and
a means for grasping the insert by suction,
said resin injection and grasping means being configured in such a way as to leave the contact surface free to be pressed against an upper face of the composite panel by a set of pressing means, so as to generate a continuous sealed zone around the cavity while the insert is being installed in the cavity, and
said effector being attached to the free end of the robot arm by means of an attachment surface;
the robot arm comprising a frame, in which a resin dispensing device, a negative pressure device and a set of negative pressure circuits are housed.

15. A method for automatically installing inserts in a cavity provided in a panel, implemented by the equipment as claimed in claim 14, comprising the following steps:
providing a panel comprising at least one cavity;
moving the effector, using the robot arm, in front of the cavity in accordance with the theoretical position of the cavity;
checking the alignment between the theoretical position of the cavity and the actual position of the cavity using the image sensor of the effector and determining the new coordinates of the actual position of the cavity;
moving the effector in front of the insert and positioning, using the image sensor, the effector in front of an insert in such a way that the image sensor is opposite the resin outlet orifice of the insert and the resin injection orifice of the effector is opposite the resin inlet orifice of the insert;
grasping the insert by suction by pressing a surface of the insert against the contact surface of the effector;
moving the effector provided with the insert in front of the cavity and positioning the insert in the cavity until the contact surface comes into contact with the upper face of the panel;
suction pressing, using the pressing means, the contact surface of the effector against the upper face of the panel in order to keep the panel in position when the resin is injected into the empty space of the cavity;
injecting the resin into the empty space delimited by the insert and the cavity through the resin injection orifice of the effector and the resin inlet orifice of the insert;
the image sensor detecting the end of the injection of resin when excess resin exits via the resin outlet orifice of the insert.
